(19) United States
(12) Patent Application Publication
(10) Pub. No.: US 2014/0146282 A1
(43) Pub. Date: May 29, 2014

(54) ADJUSTABLE EYEGLASS FRAME

(71) Applicant: HSIAO-CHIEN LU, Taipei City (TW)

(72) Inventor: HSIAO-CHIEN LU, Taipei City (TW)

(21) Appl. No.: 13/684,243

(22) Filed: Nov. 23, 2012

(51) Int. Cl. G02C 5/20

(52) U.S. Cl. CPC G02C 5/20
USPC 351/118

(57) ABSTRACT

The present invention provides an adjustable eyeglass frame comprising left and right lens frame units independent from each other and a temple unit. The left and right lens frame units further comprise insertion holes and insertion pieces configured to slide over each other for positioning and such that the relative distance between the left and right lens frame units is adjustable according to the facial width of the user. The other sides of the left and light frame units further include pivotally attached temple brackets with sliding slots. The temple unit comprises two extension rods slidable along the sliding slots of the temple brackets. Positioning can also be achieved as the positioning piece of the extension rod engages with a positioning notch of the riding slot at the inner wall of the sliding slot and such that the temple length is adjustable according to the head size of the user.

### TECHNICAL FIELD OF THE INVENTION

The present invention is related to an eyeglass frame for vision correction, in particular, to a structure of an eyeglass frame with adjustable lens frame width and temple length.

### DESCRIPTION OF THE PRIOR ART

Eyeglasses are the most common tool used for vision correction. In addition to contact lenses that are directly in contact with the surface of the eyeballs with soft lenses, conventional eyeglasses often adapts the structural design of an eyeglass frame attached with lenses for vision correction and equipped with temples for wearing of the user such as on their ears such that the eyeglasses can be worn properly in front of the eyes and facial portions of the users. As conventional eyeglass frames are of a rigid and fixed structural design without adjustable lens frame width and temple length, it is impossible for users to manually adjust the eyeglass frame in accordance to various sizes and shapes of the faces and heads of the users for greater fits and best wearing comforts.

### SUMMARY OF THE INVENTION

An objective of the present invention is to provide an adjustable eyeglass frame with an adjustable size for the wearing of various different sizes and shapes of users such that a greater comfort of the wearing of the eyeglasses with such eyeglass frame can be provided to the users.

The present invention is characterized by one feature that the lens frame units of the eyeglass frame configured to be adjusted independently prior to their removable assembly with each other such that the left and right lens frame units can be adjusted for relative distance between each other and such that the lens frame width can be adjusted according to the facial width of the user in addition to the structural positioning with positioning means provided thereon.

The present invention is also characterized by another feature that the temple unit of the eyeglass frame can be adjusted for lateral extension such that the temple length can be adjusted. In addition, the adjusted length can be locked via another positioning means such that the temple width can be adjusted according to the head size of the user for comfortable eyeglasses wearing with such adjustable temple unit.

The present invention provides an adjustable eyeglass frame comprising a left lens frame unit, a right lens frame unit, two temple brackets and a temple unit; wherein the left lens frame unit comprises an insertion hole provided on one side thereof; the insertion hole comprises a plurality of positioning grooves on an inner wall thereof; the right lens frame unit comprises an insertion piece with a positioning protrusion provided thereon; the insertion piece configured to slide into the insertion hole whereby as the insertion piece slides into the insertion hole, the positioning protrusion engages with one of the positioning grooves; the two temple brackets being pivotally attached to another side of the left lens frame and the right lens frame respectively; each one of the temple brackets comprises a sliding slot extended laterally; the sliding slot comprising a riding track extended parallel to the sliding slot and provided on one side thereof; the tiding track comprises a plurality of positioning notches provided on one side thereof; and the temple unit comprises two extension rods opposed to each other; each one of the extension rod comprises an elastic positioning means and configured to slide along the sliding slot whereby as the extension rod slides along the sliding slot, the elastic positioning means moves along the riding track to engage with one of the positioning notches.

Accordingly, each one of the elastic positioning means of the adjustable eyeglass frame of the present invention comprises a positioning piece and an elastic presser integrally formed and attached to the positioning piece and the extension rod. The positioning pieces are provided for positioning engagement with the sliding slots of the temple brackets such that the extension rods are locked by the notches in position relative to the temple brackets. As the presser is being pressed down by an user, the positioning piece releases from the locked position of the notch such that the extension rods are able to slide to another position relative to the temple brackets in order to adjust the temple length of the eyeglass frame.

For comfortable wearing of the eyeglass frame, the temple unit of the adjustable eyeglass frame of the present invention can be interconnected in parts to form a U shape such that the temple unit can be provided for not only the wearing on the ears of the user but also surrounding the rear portion of the user's head to further prevent falling off of the eyeglass frame worn.

### BRIEF DESCRIPTION OF THE DRAWINGS

FIG. 1 is an exploded view of showing the assembly of the left and right lens frame unit of the present invention;

FIG. 2 is a perspective view of an assembly of the eyeglass frame of the present invention;

FIG. 3 is a front view of the assembly of the eyeglass frame of the present invention;

FIG. 4 is a lateral side view of the temple unit with an adjustable temple length of the present invention; and

FIG. 5 is a top view of the lens frame units with an adjustable lens frame width of the present invention.

### DETAILED DESCRIPTION OF THE PREFERRED EMBODIMENTS

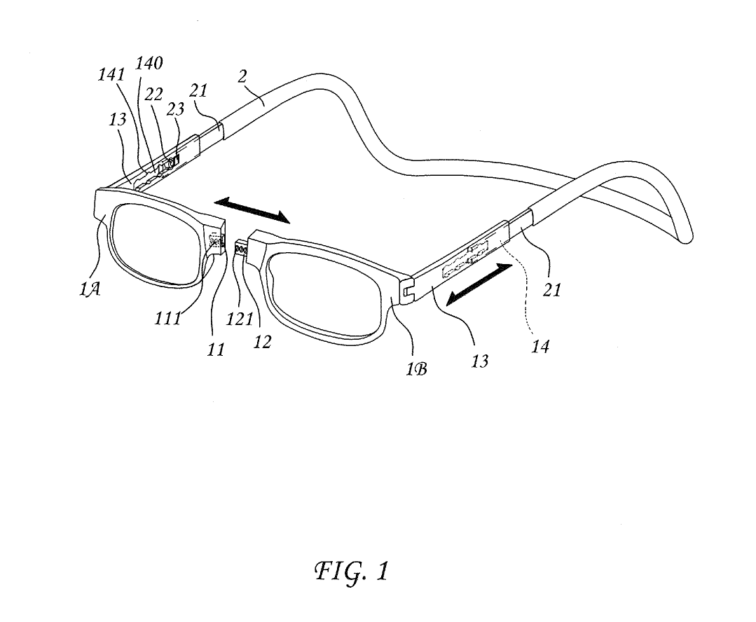

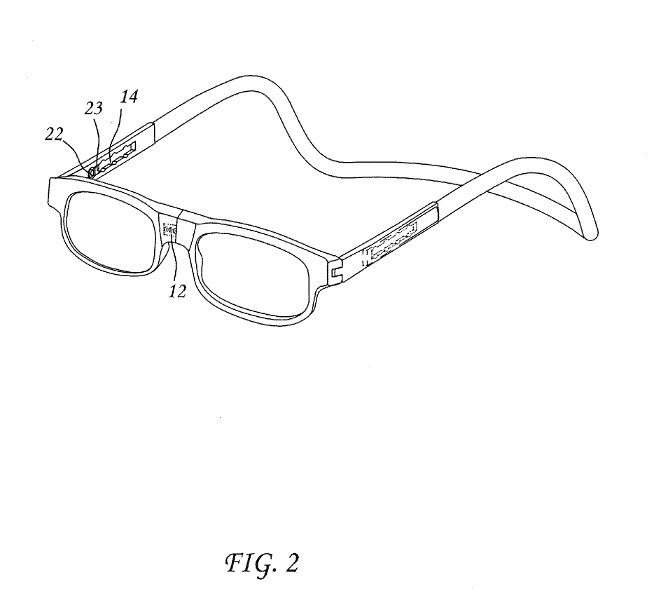

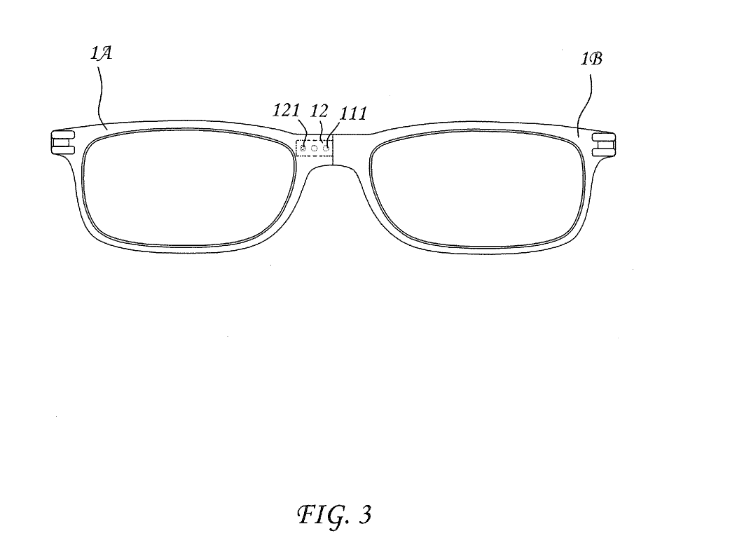

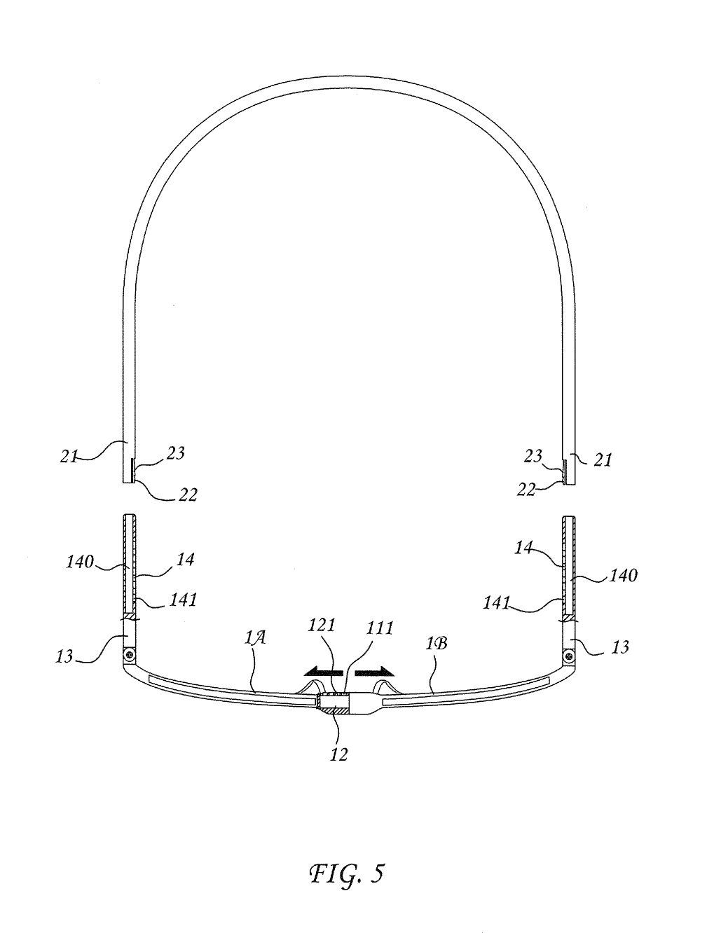

As shown in FIG. 1, the present invention provides an adjustable eyeglass frame and in one preferred embodiment, the adjustable eyeglass frame comprises a left lens frame unit 1A, a right lens frame unit 1B and a temple unit 2; wherein the left lens frame unit 1A and the right lens frame unit 1B are provided for retaining lenses and can be structurally attached to each other to form a complete lens frame combination to be worn in front of the eyes of an user for viewing. The left lens frame unit 1A and the right lens frame unit 1B are manufactured to be independent components. In addition, the left lens frame unit 1A comprises an insertion hole 11 provided on one side thereof, and the insertion hole 11 comprises a plurality of positioning grooves 111 on an inner wall thereof. As an example, the positioning groove 111 can be of a round shape and can be provided on one side of the inner wall of the insertion hole 11; however, they can also be provided on the inner walls of the two sides of the insertion hole 11. The right lens frame unit 1B comprises an insertion piece 12 corresponding to the insertion hole 11 and configured to slide into the insertion hole 11 relatively. The surface of the insertion piece 12 further comprises a positioning protrusion 121 thereon and provided for engagement with one of the positioning grooves 11. For a combination of the left lens frame unit 1A and the right lens frame unit 1B, as shown in FIG. 2, the insertion piece 12 is configured to slide into the insertion hole 11 whereby as the insertion piece 12 slides into the insertion hole 11, the positioning protrusion 121 engages with one of the positioning grooves 111 such that the left and right lens frame units are locked against any slides, as shown in FIG. 3. To slide the left and right lens frame units relative to each other again, the user only needs to apply an external force to either pulling the left and right lens frame units apart or pushing the two closer with each other such that the positioning protrusion 121 is able to overcome the friction at the inner wall of the insertion hole 11 to slide again and the positioning protrusion can therefore engage with another positioning groove 111 and locked therein. In other words, the relative distance between the left lens frame unit 1A and the right lens frame unit 1B can be adjusted to be of different lens frame widths according to the facial size and shape of the user, as shown in FIG. 5.

Again, as shown in FIG. 1, the present invention further comprises two temple brackets 13 pivotally attached to another side of the left lens frame unit 1A and the right lens frame unit 1B respectively; wherein each one of the temple brackets 13 comprises a sliding slot 14 extended laterally; the sliding slot 14 comprises a riding track 140 extended parallel to the sliding slot 14 and provided on one side thereof; and wherein the riding track 140 comprises a plurality of positioning notches 141 provided on one side thereof. In general, it is preferable to arrange the riding track 140 to be at the inner wall of the temple bracket for visual purposes without affecting the overall outer appearance of the eyeglass frame. It is also preferable to arrange the positioning notches 141 at the upper and lower edges of the two sides of the riding track 140. In addition, preferably, the positioning notches 141 on the upper and lower edges thereof are of round shapes and are arranged to be spaced apart from each other.

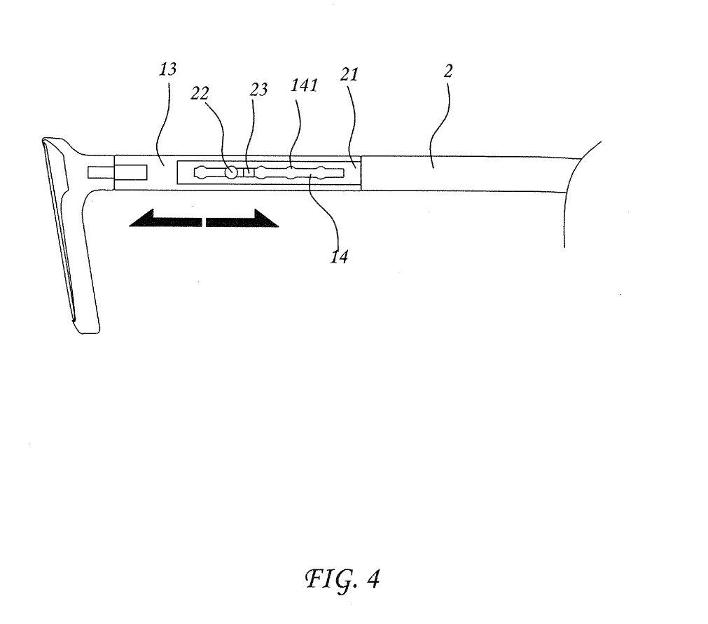

The temple unit 2 of the present invention is integrally formed of an elastic material and is interconnected in parts to form a U shape. The temple unit 2 comprises two extension rods 21 opposed to each other, and each one of the extension rod 21 comprises an elastic positioning means and configured to slide along the riding track 140 of the temple bracket 13 and the positioning grooves 141. As shown in FIGS. 4 and 5, in a preferred embodiment of the present invention, the elastic positioning means comprises a positioning piece 22 integrally formed on one side of the extension rod 21 and protruding therefrom and an elastic presser 23 attached to the positioning piece 22 and the extension rod 21; wherein the positioning piece 22 is preferably to be of a column shape corresponding to the round shape of the positioning notches 141. In view of the cooperation and the structural combination of the temple unit 2 and the temple brackets 13, as the extension rods 21 are inserted into the sliding slots 14 and as the positioning piece 22 and the presser 23 slide simultaneously along the riding tracks 140, the extension rods 21 slide along the sliding slots 14 such that the positioning pieces 22 and the presser 23 moves along the riding tracks 140 simultaneously. As the positioning piece 22 moves to a corresponding positioning notch 141, the extension rod 21 and the positioning piece 22 automatically engage with the positioning notch 141 due to their elastic forces such that the extension rods 21 and the temple brackets 13 are locked in position without further movements. When the user exerts an external force to press down the presser 23, the positioning piece 22 disengages from the positioning notch 141, which allows the extension rod 21 to slide along the sliding slot 14 again. Therefore, the relative distance between the temple unit 2 and the temple brackets 13 is adjustable according to different sizes and shapes of the heads of the users.

What is claimed is:

1. An adjustable eyeglass frame, comprising:
a left lens frame unit having an insertion hole provided on one side thereof; said insertion hole comprising a plurality of positioning grooves on an inner wall thereof;
a right lens frame unit having an insertion piece with a positioning protrusion provided thereon; said insertion piece configured to slide into said insertion hole whereby as said insertion piece slides into said insertion hole, said positioning protrusion engages with one of said positioning grooves;
two temple brackets pivotally attached to another side of said left lens frame unit and said right lens frame unit respectively; each one of said temple brackets comprising a sliding slot extended laterally; said sliding slot comprising a riding track extended parallel to said sliding slot and provided on one side thereof; said riding track comprising a plurality of positioning notches provided on one side thereof; and
a temple unit having two extension rods opposed to each other; each one of said extension rod comprising an elastic positioning means and configured to slide along said sliding slot whereby as said extension rod slides along said sliding slot, said elastic positioning means moves along said riding track to engage with one of said positioning notches.

2. The adjustable eyeglass frame according to claim 1, wherein said elastic positioning means comprises a positioning piece and an elastic presser integrally formed and attached to said positioning piece and said extension rod.

3. The adjustable eyeglass frame according to claim 1, wherein said temple unit is interconnected in parts to form a U shape.
